(19) United States
(12) Patent Application Publication
(10) Pub. No.: US 2014/0164151 A1
(43) Pub. Date: Jun. 12, 2014

(54) Gratuity Calculation Techniques

(71) Applicant: Justin Hockley, Gettysburg, PA (US)

(72) Inventor: Justin Hockley, Gettysburg, PA (US)

(21) Appl. No.: 13/892,527

(22) Filed: May 13, 2013

Related U.S. Application Data
(60) Provisional application No. 61/645,705, filed on May 11, 2012.

(51) Int. Cl. G06Q 50/12; G06Q 30/02

(52) U.S. Cl. CPC G06Q 50/12; G06Q 30/0281; G06Q 30/0283
USPC 705/15

(57) ABSTRACT

Techniques are presented herein for processing feedback information associated with one or more users of an enterprise. At a server configured to store data associated with an enterprise, a log-in request is received from an employee of the enterprise. The employee of the enterprise is authenticated by verifying log-in credentials. Upon authenticating the employee of the enterprise, a request is received from the employee for access to feedback responses associated with the employee. The feedback responses associated with the employee are sent to the employee of the enterprise.

### CROSS REFERENCE TO RELATED APPLICATIONS

This application claims priority from U.S. Provisional Application No. 61/645,705 filed on May 11, 2012, the entirety of which is incorporated by reference herein.

### TECHNICAL FIELD

The present disclosure relates to calculating an appropriate gratuity amount for a user based on feedback responses provided by the user.

### BACKGROUND

Currently, customers of restaurants and other service oriented enterprises typically provide a gratuity or “tip” in addition to other fees based on the level of service provided by the restaurant/enterprise. Customers may usually base the gratuity amount as a percentage of the overall fees, with customers usually providing relatively high tips for superior service and relatively low tips for mediocre or sub-par service provided to them. Customers may simply provide an average or high tip so as not to deviate from perceived socially acceptable tipping norms in the absence of a rationale to justify a tip that more accurately reflects the level of service. Often times, it may be difficult for customers to ascertain the level of service provided to them and to determine an appropriate tip percentage based on their overall experience at the restaurant/enterprise. Additionally, when a restaurant/enterprise receives higher than average or lower than average gratuities, it may often be difficult to determine exactly why particular tip levels were provided. Thus, a solution is needed that assists customers in providing appropriate levels of gratuity while simultaneously providing feedback that is accessible to employees of the restaurant/enterprise that details the level of service provided to the customers.

### BRIEF DESCRIPTION OF THE DRAWINGS

FIG. 1 shows an example of a system comprising a mobile device and a server device to process feedback information for a user.

FIGS. 2A-2C show example embodiments of accessing feedback information data stored in a database accessible by the server device.

FIG. 3 shows example operations performed by the user providing feedback information to the server device for the enterprise.

FIG. 4 shows an example flow chart depicting operations for the server device processing the feedback information from the user to determine an appropriate transaction between the user and the enterprise.

FIG. 5 is a block diagram of the server device that is configured to process the feedback information from the user.

### DESCRIPTION OF EXAMPLE EMBODIMENTS

### Overview

Techniques are presented herein for processing feedback information associated with one or more users of an enterprise. At a server configured to store data associated with an enterprise, a log-in request is received from an employee of the enterprise. The employee of the enterprise is authenticated by verifying log-in credentials. Upon authenticating the employee of the enterprise, a request is received from the employee for access to feedback responses associated with the employee. The feedback responses associated with the employee are sent to the employee of the enterprise.

### Example Embodiments

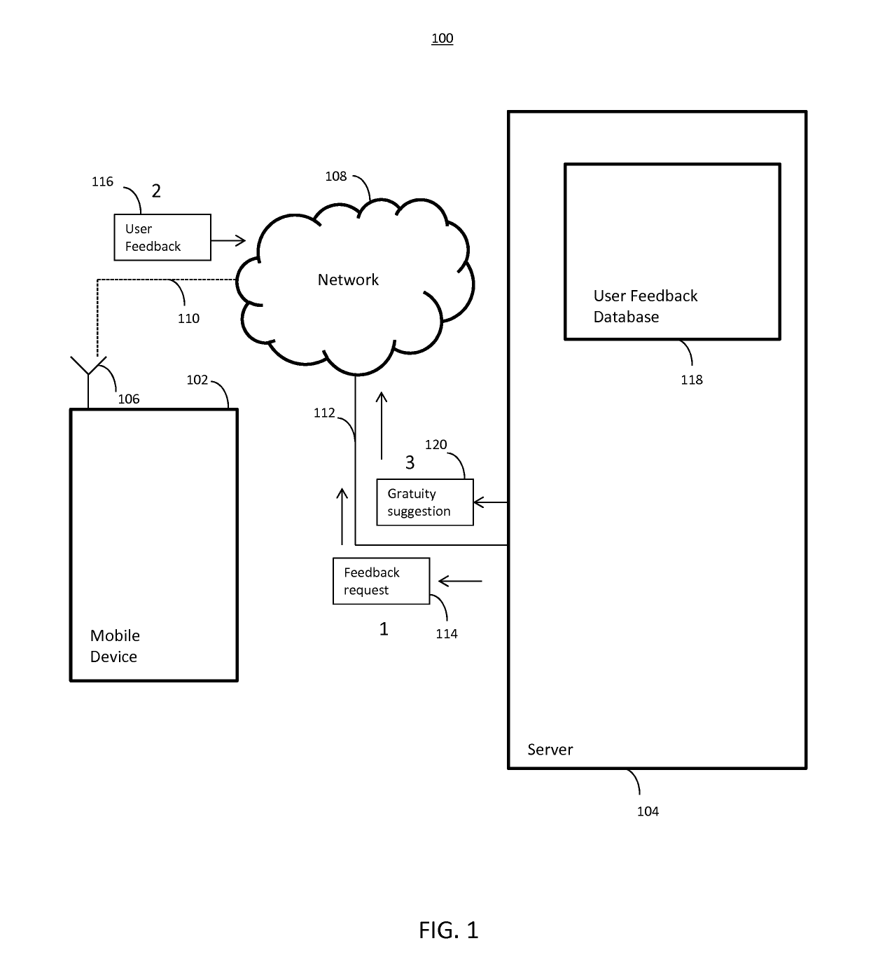

The techniques described herein relate to a system for obtaining feedback information from a user and processing the feedback information to determine an appropriate transaction between the user and an enterprise. Reference is made to FIG. 1, which shows an example system/topology (hereinafter “system”) at reference numeral 100. The system 100 comprises a mobile device 102 and a server device (e.g., “server”) 104. The mobile device 102 has an antenna 106 that is configured to send messages to and receive messages from (e.g., wirelessly) the server 104 via a network 108. For example, the network 108 may be a Local Area Network (LAN) or a Wide Area Network (WAN), e.g., the Internet, and messages may be sent between mobile device 102 and the server 104 via the network 108. FIG. 1 shows a wireless connection 110 between the mobile device 102 and the network 108 and a wired connection 112 between the server 104 and the network 108. However, it should be appreciated that connections 110 and 112 may be either wireless connections or wired connections.

A user, not shown in FIG. 1, is configured to use the mobile device 102 to send messages to and receive messages from the server 104. The messages may be data communications and/or data packets. Additionally, the system 100 may have other devices not show in FIG. 1 (e.g., other mobile devices or other types of computing devices such as desktop computers, laptops, tablets, etc.) whereby users can exchange messages with the server 104. For simplicity, a single user is described in connection with FIG. 1, though it should be appreciated that multiple users and multiple devices may be present in the system 100.

In an example embodiment, the user may be a customer or patron of an enterprise. The enterprise may be any business or other entity rendering services to the user. For example, the enterprise may be restaurant, taxi service, food delivery service, concierge service, etc. For simplicity, the examples herein describe the enterprise as a restaurant and accordingly, the terms “enterprise” and “restaurant” may be used interchangeably. It should be appreciated, however, that the techniques described are not intended to limit the applicability of the system 100 to restaurants or any other type of business entity in particular.

The system 100, in general, allows for the user to provide feedback with respect to the services rendered by an enterprise. The feedback is processed by the server 104 to determine an appropriate transaction between the user and the enterprise. For example, a user may be a customer of a restaurant, and the system 100 may allow the user to submit feedback (e.g., via the mobile device 102) to the server 104 such that the server can process the feedback and can calculate an appropriate gratuity amount to be provided by the user. As will become apparent herein, the gratuity amount may be calculated by the server 104 based on feedback provided by the user. The feedback provided describes the overall user experience at the restaurant, the user experience of services rendered by particular employees of the restaurant (e.g., wait staff and/or managers), prior user experience at the restaurant, etc. The user may be provided with a rating scale to rate various service related aspects of the restaurant, and the server 104, upon receiving this information may compute or calculate an appropriate gratuity level based on the answers provided by the user. The server 104 may compute or calculate the appropriate gratuity level based on, for example, predetermined algorithms designed to equate a gratuity percentage to the level of service received by the user. For example, the server 104 may compute the appropriate gratuity level by evaluating a weighted grading of a dining (or other analogous) experience based on feedback provided by the user.

As shown in FIG. 1, a series of messages may be exchanged between the mobile device 102 and the server 104 via the network 108. The user, for example, may log-in to the gratuity computation service provided by the server 104. The user may log-in via a mobile application that is run by the mobile device 102 (or any other device that is in communication with the server 104 over, e.g., the Internet). This mobile application may be, e.g., an application that runs on mobile operating platforms such as Android™, iOS™, etc. Upon logging-in and selecting a restaurant (e.g., via the mobile device 102), the server 104 may send a request message to the user via the mobile device 102. The request message is shown at reference numeral 114 as a “feedback request” message. The feedback request message 114 may comprise one or more prompts (e.g., questions or categories for the user to rate or comment on) to solicit feedback from the user for each of the prompts.

Upon receiving the feedback request message 114, the user may send, via the mobile device 102, a response message comprising user feedback. This response message is shown as “user feedback” message 116 in FIG. 1. The user feedback message 116 may comprise feedback responses for the one or more prompts in the feedback request message. Additionally, the user feedback message 116 may comprise other feedback responses (e.g., general text comments and specific text comments for each of the prompts) entered by the user via the mobile device 102.

Upon receiving the user feedback message 116, the server 104 may evaluate the user feedback message 116 and may process the responses contained in the user feedback message 116. The server 104 may then store these feedback responses in a user feedback database, shown at reference numeral 118. FIG. 1 shows the user feedback database 118 stored at the server 104, but it should be appreciated that the user feedback database 118 may be stored remotely from the server 104 and may be accessible by the server 104. After processing the responses in the user feedback message 116 (e.g., using one or more preselected processing algorithms), the server 104 may determine an appropriate transaction between the user and the restaurant. For example, the appropriate transaction may refer to an appropriate gratuity amount to be provided by the user to the employee who served the user at the restaurant. The server 104 may then send this gratuity suggestion to the user. The gratuity suggestion message is shown at reference numeral 120 (e.g., and may be referred to herein as a gratuity suggestion notification). Upon receiving the gratuity suggestion message 120 from the server 104, the user can decide whether or not to provide the gratuity as recommended in the gratuity suggestion message 120. In one embodiment, the gratuity recommend in the gratuity suggestion message 120 may be added to the user's bill automatically. Gratuity suggestions may correlate with the feedback provided such that a relatively high gratuity amount is calculated when the feedback responses from the user are positive feedback responses and a relatively low gratuity amount is calculated when the feedback responses from the user are negative feedback responses.

As stated above, upon receiving the user feedback responses, the server 104 may store the responses in the user feedback database 118. Thus, users may be able to access previous feedback responses for a particular restaurant, and these previous feedback responses may be used as part of the gratuity recommendation computation. The gratuity suggestion calculation that is performed by the server 104, thus, may provide value to the user by suggesting appropriate gratuity percentages (and amounts) based on, e.g., prior and/or current levels of service provided by a restaurant. The information stored in the user feedback database 118, however, may also be valuable to the restaurant itself. For example, the restaurant may use the feedback information stored in the user feedback database 118 to evaluate specific employees (e.g., wait staff) and to perform analytics on the user feedback to determine the levels and quality of service experienced by users of the restaurant. The restaurant may use this information, for example, to correct persistent areas of poor service and to reward and/or discipline employees based on the level or quality of service experience by users. In another example, when an enterprise comprises more than one restaurant location, the enterprise can analyze data in the user feedback database to compare the different restaurant locations with one another and with other comparable restaurants nearby. The restaurant may also use the information in the user feedback database to evaluate “reputation scores” of employees or prospective employees to ensure that an adequate level of service is provided to customers. In one embodiment of the techniques herein, the restaurant may have the opportunity to adjust the scoring system of questions and corresponding calculations to meet its unique requirements. Additionally, analytics from the feedback information may provide insights into individual employees as well as particular consumer habits. Such information can be provided securely to interested parties via a smart device or emailed report and could facilitate employer/employee goal setting and performance improvement planning.

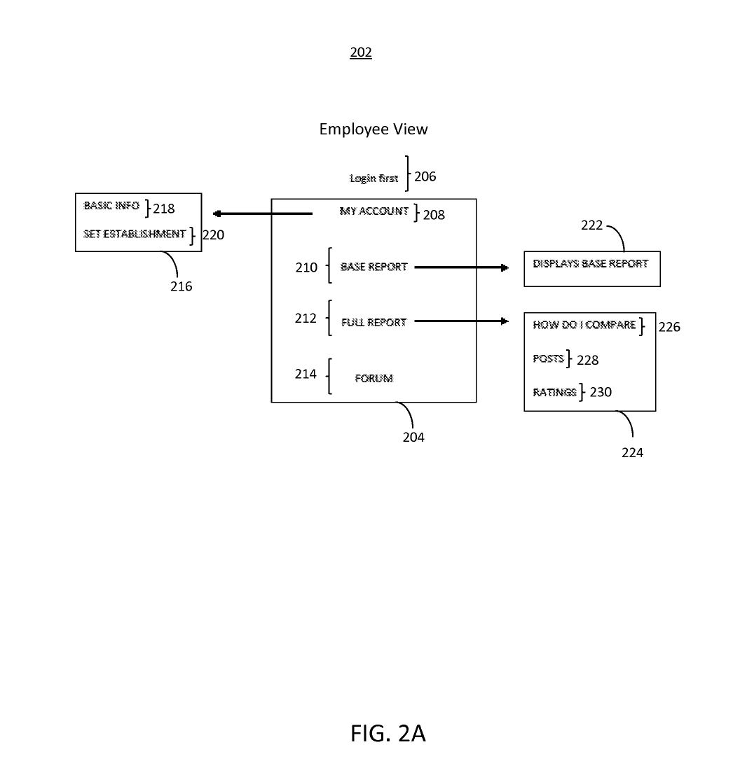

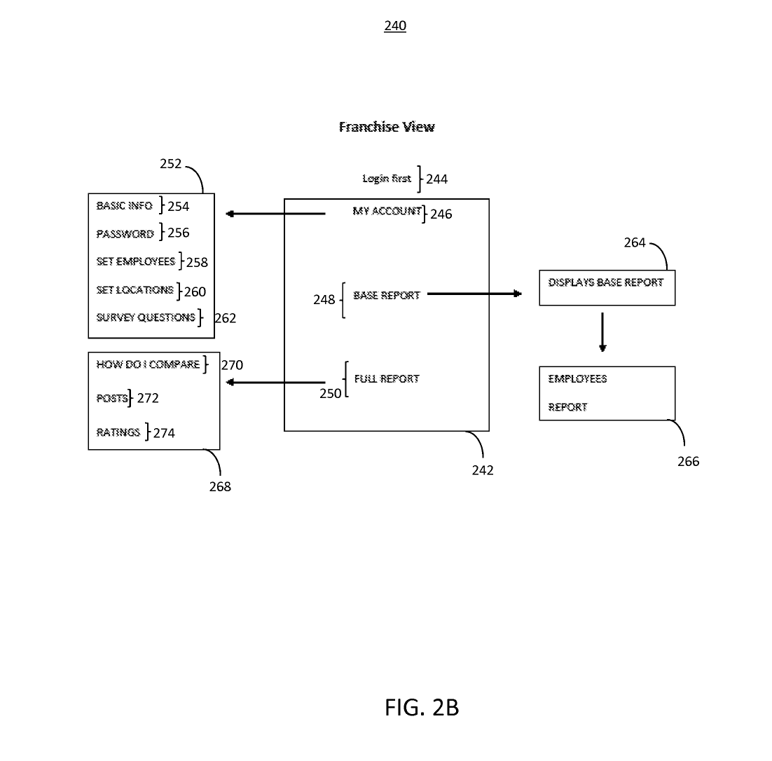

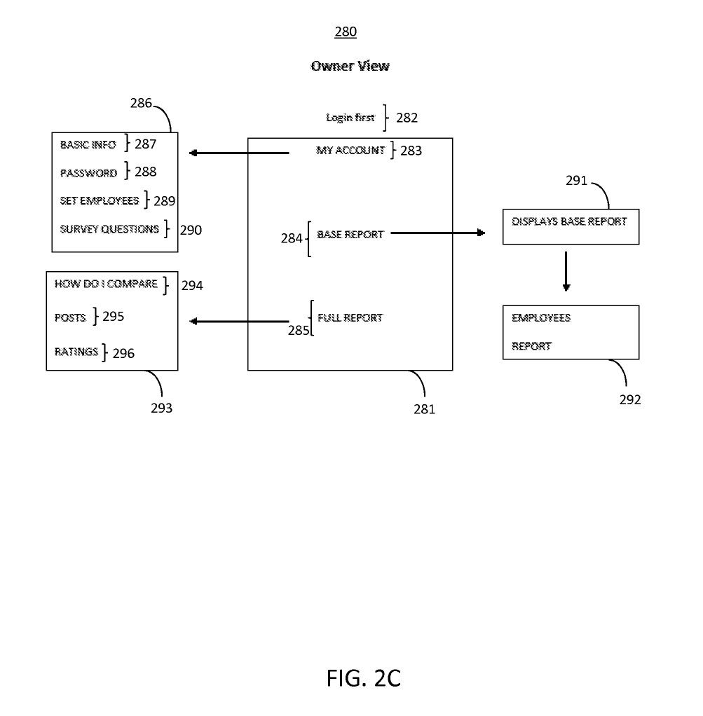

Reference is now made to FIGS. 2A-2C. FIGS. 2A-2C show example embodiments of accessing feedback information data that is stored in the user feedback database 118 accessible by the server 104. As stated above, the user feedback database 118 may be stored at the server 104 or may be stored remotely and may be accessed by the server 104. FIG. 2A shows, at reference numeral 202, an example embodiment of data accessible by an employee of a restaurant. In particular, reference numeral 202 shows an example list of options presented to the employee when the employee accesses the server 104 via an application on his or her phone (or other device) or via a website. In one embodiment, the application is the same application that the user may utilize to enter feedback responses. The application may have different viewing settings that are configured based on a user log-in. Thus, the employee may have an “employee” or “wait staff” account that enables the employee to access the information depicted in FIG. 2A.

As shown in FIG. 2A at reference numeral 204, the employee may be presented with a list of options which enable the employee to obtain data from the user feedback database 118. For example, the employee may first log-in, as shown at reference numeral 206, and upon logging-in (and being authenticated), the employee may retrieve information shown at headers 208, 210, 212 and 214. For example, if the employee selects (e.g., by clicking or tapping a hyperlink) the information associated with heading 208 (“My Account”), the employee may be able to select data associated with basic information 222 and may be able to set his or her place of employment. These options are shown at reference numeral 216 under the heading “Basic Info” 218 and “Set Establishment” 220, respectively. If the employee selects the information associated with the heading 210 (“Base Report”), the server 104 will retrieve a base report comprising a summary of various feedback responses provided by users for the employee and for the restaurant. For example, the employee may be provided with an overall score that is an aggregate composite of user feedback for the employee.

The employee may also select information associated with the heading 212 (“Full Report”). The Full Report information may comprise detailed information for user feedback received for various categories of review. The employee can use this information to determine specific categories in which he or she may have, for example, above average, average or poor ratings. Additionally, the employee may be able to view text comments submitted by users as a part of the feedback responses. As shown in FIG. 2A, the Full Report information 224 may also provide information comparing the employee to other employees (as shown at reference numeral 226) or employees in a geographic area nearby and additionally may provide information regarding text reviews (e.g., posts) for the employee (shown at reference numeral 228) and ratings reviews (as shown at reference numeral 230). Additionally, the employee may select information associated with the heading 214 (“Forum”), which, in one example, provides the employee with access to feedback contributions made by several users to the forum.

Reference is now made to FIG. 2B, which shows, at reference numeral 240, an example list of options presented to a franchise (e.g., having a franchise account for the application) to access information. As shown in FIG. 2B, at reference numeral 242, the franchise may be presented with a list of options that enable the franchise account member to obtain user feedback information from the user feedback database 118. For example, the franchise account member must first log-in, as shown at reference numeral 244, and upon logging-in and being authenticated, the franchise account member can retrieve information shown at headers 246, 248 and 250. For example, if the franchise account member selects (e.g., by clicking or tapping a hyperlink) the information associated with heading 246 (“My Account”), the franchise account member is presented with information 252. Information 252 allows the franchise account member to view basic information (254) associated with the account, password information (256), employee information (258), location information (260) of various restaurants within a franchise and survey questions (262) to be sent to users as prompts for user feedback.

If the franchise account member selects the information associated with the heading 248 (“Base Report”), the server 104 will retrieve a base report comprising a summary of various feedback responses provided by the users for restaurants in the franchise including, e.g., a summary for each individual location and employees at each individual location. This information is shown at reference numerals 264 and 266, respectively. If the franchise account member selects information associated with the heading 250 (“Full Report”), the server 104 will retrieve information 268, which comprises, e.g., comparison information 270 (e.g., comparisons with other franchises of the enterprise and/or other restaurants nearby), post information 272 (e.g., showing posts made by users) and ratings information 274 (e.g., showing ratings provided by users for specific categories of review).

Reference is now made to FIG. 2C, which shows, at reference numeral 280, an example list of options presented to a particular restaurant owner (“owner”) to access information. As shown in FIG. 2C, at reference numeral 281, the owner may be presented with a list of options that enable the owner to obtain user feedback information from the user feedback database 118. For example, the owner must first log-in, as shown at reference numeral 282, and upon logging-in and being authenticated, the owner can retrieve information shown at headers 283, 284 and 285. For example, if the owner selects the information associated with the heading 283 (“My Account”), the owner is presented with information 286. Information 286 allows the owner to view basic information (287) associated with the account, password information (288), employee information (289) and survey questions (290) to be sent to users as prompts for user feedback.

If the owner selects the information associated with the heading 284 (“Base Report”), the server 104 will retrieve a base report comprising a summary of various feedback responses provided by the users (e.g., customers) of the restaurant and a summary of feedback associated with employees. This information is shown at reference numerals 291 and 292, respectively. If the owner selects information associated with the heading 285 (“Full Report”), the server 104 will retrieve information 293, which comprises comparison information 294 (e.g., comparisons with other restaurants), post information 295 (e.g., showing posts made by users) and ratings information 296 (e.g., showing ratings provided by users for specific categories of review).

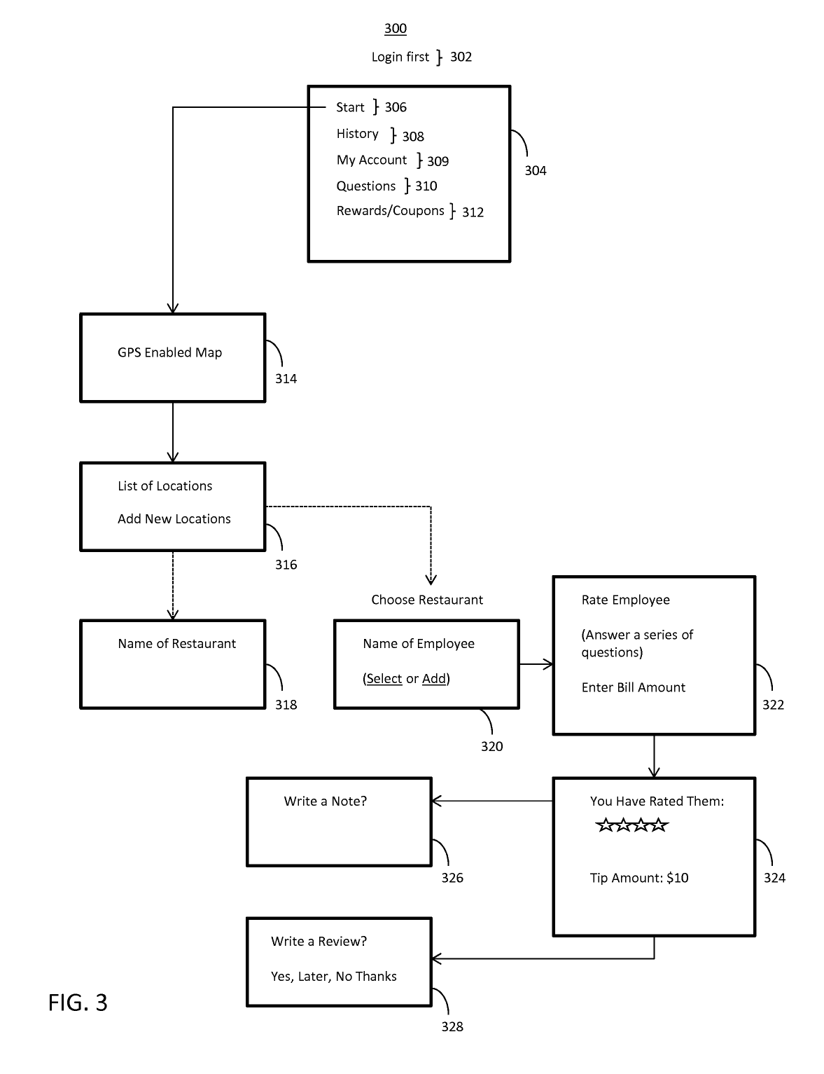

Reference is now made to FIG. 3, which shows example operations 300 performed by a user (customer) providing feedback information to the server 104 for a restaurant. The operations 300 may be performed via a software application (e.g., a mobile application). At 302, the user enters log-in information using, e.g., a unique identity. After the user has logged-in (and whose log-in credentials have been authenticated by the server 104), the user at 304 is presented with a series of options. The user 304 can start the gratuity calculation process at option 306, or can select from various other options shown at reference numerals 308-312. For example, option 308 is a “History” option which lists favorite restaurants/employees for the user. The History option 308 may present the user with history of locations that the user has previously rated/reviewed and a history of employees or wait staff previously rated/reviewed by the user. Option 309 is a “My Account” option that lists account information, profile, home location information and email notifications for the user. Option 310 is a “Questions” option that allows the user to submit questions regarding the operation of the software application. Option 312 is a “Rewards” option that shows deals and coupons for local area restaurants. For example, coupons based on a user's habits and location may be presented to the user via an advertisement or an email. In one example, the “Rewards” option may contain specific credits for a user to be used at various restaurants.

When the user selects the “Start” option 306, the software application then proceeds to operation 314, which displays a Global Positioning System (GPS) enabled map to the user. At option 316, a list of locations is provided to the user. The list may comprise names for a plurality of restaurants, as shown at reference numeral 318. Option 316 also allows the user to add a new location. After selecting a restaurant and/or adding a new restaurant, the user is able, at operation 320, to review a list of employees (e.g., wait staff). The user can select or add a wait staff employee for whom a rating will be provided. At operation 322, the user is given the option of rating the employee 322 by, e.g., answering a series of questions. For example, the questions may pertain to an employee's attentiveness, knowledge of and assistance with food items on the menu, attitude, etc. The questions may be answered as numerical ratings (e.g., one through ten) in each category from which the system 100 calculates the appropriate gratuity. The answers to the questions are stored in the user feedback database 118, as described above.

The user also enters the amount for the bill. Option 322 may be a page that continuously scrolls along a home page of the display to the user. At operation 324, the user is shown a review of how the employee has been rated, and presents a gratuity suggestion to the user. The gratuity suggestion may be determined by using a calculation that, for example, starts with a predetermined percentage of the bill (e.g., 18%) and deducts or adds percentage points or fractions thereof in accordance with the user's indicated satisfaction or dissatisfaction with each category of service. It should be understood, however, that other questions, grading criteria and grading algorithms may be used to calculate the gratuity. The user may also be presented with options on how to spilt the bill among multiple customers. At operation 326, the user is provided with an option to add additional text as a part of the employee/restaurant feedback, or at operation 328 to write a review for the software application itself. Additionally, the user may be provided with the option of rating the restaurant on one or more social networking platforms.

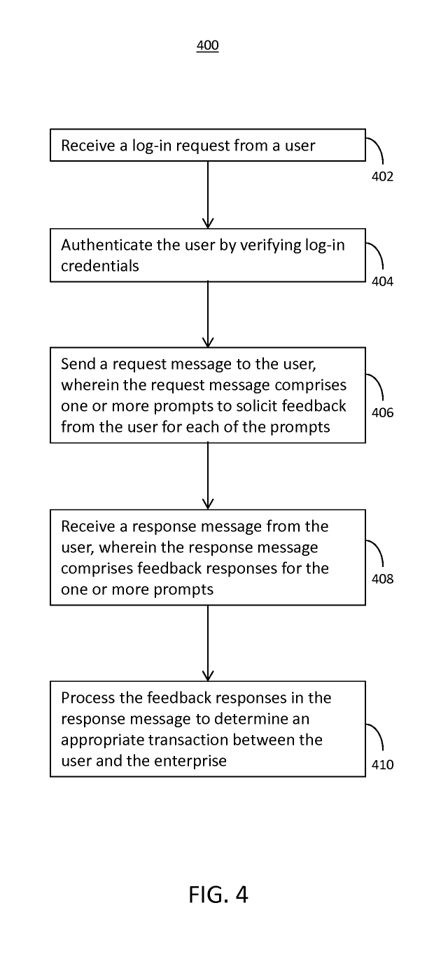

Reference is now made to FIG. 4, which shows an example flow chart 400 depicting operations for the server 104 processing the feedback information from the user to determine an appropriate transaction between the user and the enterprise. At operation 402, the server 104 receives a log-in request from a user. At operation 404, the server 104 authenticates the user by verifying log-in credentials, and at operation 406, the server 104 sends a request message to the user. The request message comprises one or more prompts to solicit feedback from the user for each of the prompts. At operation 408, a response message is received from the user. The response message comprises feedback responses for the one or more prompts. At operation 410, the feedback responses are processed in the response message to determine an appropriate transaction between the user and the enterprise.

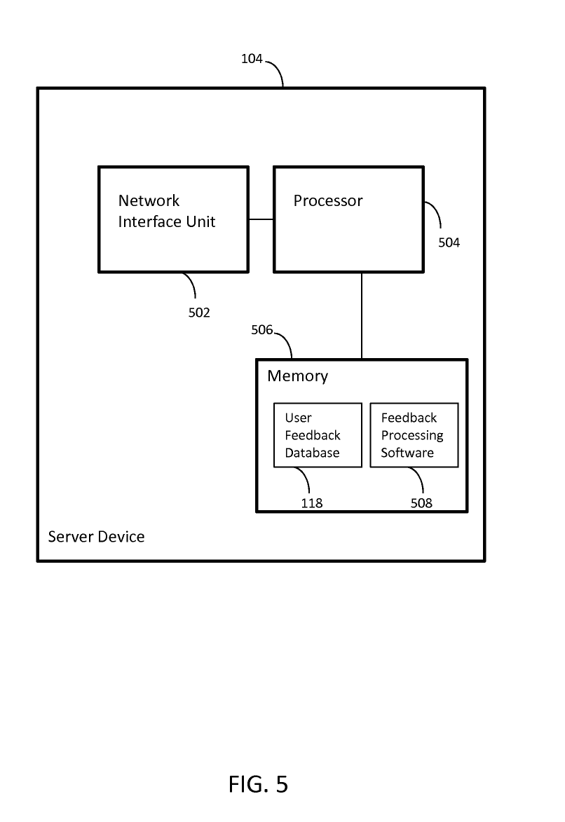

Reference is now made to FIG. 5, which shows an example block diagram of the server device (“server”) 104 with software configured to process user feedback. The server 104 comprises, among other units, a network interface unit 502, a processor 504 and a memory 506. The network interface unit 502 is configured to send and receive communications (e.g., data packets and other communications) to devices in the system 100. The processor 504 is, for example, a microprocessor or microcontroller that is configured to execute program logic instructions (i.e., software) for carrying out various operations and tasks of the server 104, as described herein. For example, the processor 504 is configured to execute the feedback processing software 508 in the memory 506 to generate gratuity suggestions for the user based on user feedback and to provide information to employees, restaurants and franchises. The functions of the processor 504 may be implemented by logic encoded in one or more tangible computer readable storage media or devices (e.g., storage devices compact discs, digital video discs, flash memory drives, etc. and embedded logic such as an application specific integrated circuit, digital signal processor instructions, software that is executed by a processor, etc.).

The memory 506 may comprise read only memory (ROM), random access memory (RAM), magnetic disk storage media devices, optical storage media devices, flash memory devices, electrical, optical, or other physical/tangible (non-transitory) memory storage devices. The memory 506 stores instructions for the feedback processing software 508. Additionally, the memory 506 may store the user feedback database 118. Thus, in general, the memory 506 may comprise one or more computer readable storage media (e.g., a memory storage device) encoded with software comprising computer executable instructions and when the software is executed (e.g., by the processor 502) it is operable to perform the operations described herein.

The feedback processing software 508 may take any of a variety of forms, so as to be encoded in one or more tangible computer readable memory media or storage device for execution, such as fixed logic or programmable logic (e.g., software/computer instructions executed by a processor), and the processor 502 may be an application specific integrated circuit (ASIC) that comprises fixed digital logic, or a combination thereof.

In still another example, the processor 502 may be embodied by digital logic gates in a fixed or programmable digital logic integrated circuit, which digital logic gates are configured to execute the feedback processing software 508. In general, the feedback processing software 508 may be embodied in one or more computer readable storage media encoded with software comprising computer executable instructions and when the software is executed operable to perform the operations described above.

It should be appreciated that the techniques described above in connection with all embodiments may be performed by one or more computer readable storage media that is encoded with software comprising computer executable instructions to perform the methods and steps described herein. For example, the operations performed by the server 104 may be performed by one or more computer or machine readable storage media (non-transitory) or device executed by a processor and comprising software, hardware or a combination of software and hardware to perform the techniques described herein.

In summary, a method is provided for processing feedback information associated with one or more users, the method comprising: at a server device configured to store data associated with an enterprise, receiving a log-in request from an employee of the enterprise; authenticating the employee of the enterprise by verifying log-in credentials; upon authenticating the employee of the enterprise, receiving a request from the employee of the enterprise for access to feedback responses associated with the employee; and sending to the employee of the enterprise the feedback responses associated with the employee.

Additionally, a method is provided for processing feedback information from a user, the method comprising: at a server device configured to store data associated with an enterprise, receiving a log-in request from an owner of the enterprise; authenticating the owner of the enterprise by verifying log-in credentials; upon authenticating the owner of the enterprise, receiving a request from the owner of the enterprise for access to feedback responses associated with the enterprise; and sending to the owner of the enterprise the feedback responses associated with the enterprise.

Furthermore, a method is provided for processing feedback information from a user. The method comprises: receiving, at a server device configured to store data associated with an enterprise receiving a log-in request from the user; authenticating the user by verifying log-in credentials; sending a request message to the user, wherein the request message comprises one or more prompts to solicit feedback from the user for each of the prompts; receiving a response message from the user, wherein the response message comprises feedback responses for the one or more prompts; processing the feedback responses in the response message to determine an appropriate transaction between the user and the enterprise.

The above description is intended by way of example only. Various modifications and structural changes may be made therein without departing from the scope of the concepts described herein and within the scope and range of equivalents of the claims.

What is claimed is:

1. A method for processing feedback information associated with one or more users, the method comprising:
at a server device configured to store data associated with an enterprise, receiving a log-in request from an employee of the enterprise;
authenticating the employee of the enterprise by verifying log-in credentials;
upon authenticating the employee of the enterprise, receiving a request from the employee of the enterprise for access to feedback responses associated with the employee; and
sending to the employee of the enterprise the feedback responses associated with the employee.

2. The method of claim 1, wherein sending comprises sending the feedback responses that comprise information pertaining to at least one of ratings information submitted by a user for the employee and comments submitted by the user for the employee.

3. The method of claim 1, wherein sending comprises sending the feedback responses that comprise information related to a gratuity amount provided by the user to the employee.

4. The method of claim 1, wherein sending comprises sending the feedback responses that comprise responses provided by the user to questions about quality of services provided by the employee.

5. The method of claim 1, wherein sending comprises sending the feedback responses that comprise information that compares the feedback responses associated with the employee to feedback responses of other employees of the enterprise.

6. The method of claim 1, wherein sending comprises sending the feedback responses that comprise information that compares the feedback responses associated with the employee to feedback responses of other employees in a same geographic region of the employee.

7. A method for processing feedback information from a user, the method comprising:
at a server device configured to store data associated with an enterprise, receiving a log-in request from an owner of the enterprise;
authenticating the owner of the enterprise by verifying log-in credentials;
upon authenticating the owner of the enterprise, receiving a request from the owner of the enterprise for access to feedback responses associated with the enterprise; and
sending to the owner of the enterprise the feedback responses associated with the enterprise.

8. The method of claim 7, wherein sending comprises sending the feedback responses that comprise information pertaining to at least one of ratings information submitted by a user for the enterprise and for employees of the enterprise and comments submitted by the user for the enterprise and the employees of the enterprise.

9. The method of claim 7 wherein sending comprises sending the feedback responses that comprise information related to a gratuity amount provided by the user.

10. The method of claim 7, wherein sending comprises sending the feedback responses that comprise responses provided by the user to questions about quality of services provided by the employees of the enterprise.

11. The method of claim 7, wherein sending comprises sending the feedback responses that comprise information that compares the feedback responses associated with the enterprise to feedback responses of other enterprises.

12. The method of claim 7, wherein receiving comprises receiving the log-in request from the owner of the enterprise, wherein the enterprise comprises one or more locations.

13. The method of claim 12, wherein sending comprises sending the feedback responses associated with each of the locations of the enterprise.

14. The method of claim 7, wherein sending comprises sending the feedback responses that comprise individual ratings for each of the employees of the enterprise.

15. A method for processing feedback information from a user, the method comprising:
at a server device configured to store data associated with an enterprise, receiving a log-in request from the user;
authenticating the user by verifying log-in credentials;
sending a request message to the user, wherein the request message comprises one or more prompts to solicit feedback from the user for each of the prompts;
receiving a response message from the user, wherein the response message comprises feedback responses for the one or more prompts;
processing the feedback responses in the response message to determine an appropriate transaction between the user and the enterprise.

16. The method of claim 15, further comprising:
receiving a request for access to the feedback responses from an employee of the enterprise; and
providing to the employee the feedback responses associated with the employee, wherein the feedback responses comprise information pertaining to at least one of ratings information submitted by the user for the employee and comments submitted by the user for the employee.

17. The method of claim 15, further comprising:
receiving a request for access to the feedback responses from the enterprise;
providing to the enterprise the feedback responses associated with the enterprise, wherein the feedback responses comprise information pertaining to at least one of ratings information submitted by the user for employees of the enterprise, ratings information submitted by the user for the enterprise, comments submitted by the user for the employees of the enterprise and comments submitted by the user for the enterprise.

18. The method of claim 15, wherein processing the response message to determine the appropriate transaction comprises:
calculating an appropriate gratuity amount to be provided by the user; and
sending a notification of the appropriate gratuity amount to the user.

19. The method of claim 18, wherein calculating comprises:
calculating a relatively high gratuity amount when the feedback responses from the user are positive feedback responses; and
calculating a relatively low gratuity amount when the feedback responses from the user are negative feedback responses.

20. The method of claim 15, wherein processing comprises processing the feedback responses in the response message together with prior feedback response messages previously submitted by the user to determine the appropriate transaction between the user and the enterprise.
